(19) United States
(12) Patent Application Publication
(10) Pub. No.: US 2025/0021398 A1
(43) Pub. Date: Jan. 16, 2025

(54) DISTRIBUTION OF VOLTAGE-CONDUCTANCE POINTS FOR ARTIFICIAL NEURAL NETWORKS

(71) Applicant: Micron Technology, Inc., Boise, ID (US)

(72) Inventors: Febin Sunny, Folsom, CA (US); Poorna Kale, Folsom, CA (US)

(21) Appl. No.: 18/767,593

(22) Filed: Jul. 9, 2024

Related U.S. Application Data
(60) Provisional application No. 63/513,716, filed on Jul. 14, 2023.

(51) Int. Cl. G06F 9/50; G06F 11/30

(52) U.S. Cl. CPC G06F 9/505; G06F 11/3062; G06F 2209/5022

(57) ABSTRACT

Updating a distribution of voltage-conductance points for artificial neural networks can include receiving, at an accelerator, such as a MAC unit, information corresponding to a memory array of the MAC unit. A plurality of parameters of the ANN can be received. The distribution of voltage-conductance points can be identified utilizing the plurality of parameters and based on the information corresponding to the memory array. The distribution of voltage-conductance points correspond to discernable conductance levels and a subset of the plurality of parameters. The ANN can be stored in the MAC unit based on the discernable conductance levels.

### PRIORITY INFORMATION

This Application claims the benefit of U.S. Provisional Application No. 63/513,716, filed Jul. 14, 2023, the contents of which are included herein by reference.

### TECHNICAL FIELD

The present disclosure relates generally to apparatuses, non-transitory machine-readable media, and methods associated with updating a distribution of voltage-conductance points for Artificial Neural Networks.

### BACKGROUND

A computing device can be, for example, a personal laptop computer, a desktop computer, a smart phone, smart glasses, a tablet, a wrist-worn device, a mobile device, a digital camera, and/or redundant combinations thereof, among other types of computing devices.

Computing devices can be used to perform operations. Performing operations can utilize resources of the computing devices. Performing operations can utilize memory resources, processing resources, and power resources, for example. The operations performed can be affected by characteristics of the memory device.

### BRIEF DESCRIPTION OF THE DRAWINGS

FIG. 1 illustrates an example computing system for updating a distribution of voltage-conductance points for Artificial Neural Networks in accordance with some embodiments of the present disclosure.

FIG. 2 illustrates graphs showing quantization profiles in accordance with some embodiments of the present disclosure.

FIG. 3 illustrates graphs showing a quantization profile and a distribution of parameters of an Artificial Neural Network in accordance with some embodiments of the present disclosure.

FIG. 4 is a functional block diagram for updating a distribution of voltage-conductance points in accordance with some embodiments of the present disclosure.

FIG. 5 is a flow diagram corresponding to a method for updating a distribution of voltage-conductance points in accordance with some embodiments of the present disclosure.

FIG. 6 is a block diagram of an example computer system in which embodiments of the present disclosure may operate.

### DETAILED DESCRIPTION

Apparatuses, machine-readable media, and methods related to updating a distribution of voltage-conductance points for artificial neural networks (ANNs) are described. An accelerator comprising a multiply and accumulate (MAC) unit can receive information corresponding to a memory array of the MAC unit. The accelerator can also receive a plurality of parameters of an ANN. The accelerator can identify a distribution of voltage-conductance points utilizing the plurality of parameters and based on the information corresponding to the memory array. The distribution of voltage-conductance points can have discernable conductance levels that correspond to a subset of the plurality of parameters. The ANN can be stored in the MAC units based on the discernable conductance levels. As used herein, a MAC unit is hardware that computes the product of two values and adds the product to an accumulator.

Values generated in a digital domain can be converted to an analog domain to store the values in memory. In some approaches, the conversion of the values may assume a uniform distribution of voltage levels to conductance levels (e.g., uniform voltage-conductance points) for reading and storing the values in multi-level cells (MLC). A voltage-conductance point, as described in more detail herein, refers to a voltage that causes an MLC to conduct for a particular data state. MLCs programmed to different data states will conduct in response to different respective voltages being applied thereto. There are many factors that can affect the distribution of voltage levels to conductance levels for reading and storing to MLCs. The presence of these factors can cause errors in storing or reading values stored in the MLCs.

Aspects of the present disclosure address the above and other deficiencies by updating a distribution of voltage-conductance points for ANNs. The ANNs can include weights, biases, and/or activation functions. The weights, biases, and/or activation functions of the ANNs can be referred to as parameters of the ANN. The parameters can also be referred to as values. The parameters can be stored in MAC units of an accelerator configured to execute the ANN. The voltage-conductance points used to store and/or read the parameters from the MAC units can be updated based on information associated with the memory arrays of the MAC units. The information associated with the memory array of the MAC units can describe various noise sources present in the MAC units which are implemented in the analog domain. The information associated with the memory array of the MAC units can not only describe the noise sources but also their modelling. The noise sources can be operational noise sources.

As used herein, voltage-conductance points are voltage levels and corresponding conductance levels which are correlated. The voltage-conductance points are associated with parameters of the ANN to generate a quantization profile. As used herein, an ANN can provide learning by forming probability weight associations between an input and an output. The probability weight associations can be provided by a plurality of nodes that make up the ANN. The nodes together with weights, biases, and/or activation functions can be used to generate an output of the ANN based on the input to the ANN. A plurality of nodes of the ANN can be grouped to form layers of the ANN. An ANN can be implemented using an accelerator such as a deep learning accelerator. As used herein, a deep learning accelerator can include hardware configured to perform machine learning operation including operation utilized to implement an ANN.

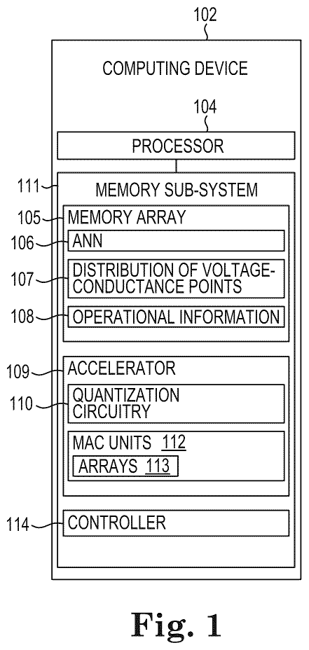

FIG. 1 illustrates an example computing system for updating a distribution of voltage-conductance points for ANNs in accordance with some embodiments of the present disclosure. The computing system can include a computing device 102. The computing device 102 can include the processor 104 and the memory sub-system 111. The memory sub-system includes the memory array 105, the accelerator 109, and the controller 114.

The memory sub-system 111 can be hardware, firmware, and/or software configured to implement an ANN 106 using the accelerator 109. The memory sub-system 111 (e.g., a non-transitory MRM) can store instructions and/or data (e.g., ANN 106, distribution of voltage-conductance points 107, and operational information 108). Although the following description refers to a processing device and a memory device, the description may also apply to a system with multiple processing devices and multiple memory devices. In such examples, the instructions may be distributed across (e.g., stored by) multiple memory devices and the instructions may be distributed across (e.g., executed by) multiple processing devices.

The memory sub-system 111 may include memory devices. The memory devices may be electronic, magnetic, optical, or other physical storage device that stores executable instructions. One or both of the memory devices may be, for example, non-volatile or volatile memory. In some examples, one or both of the memory devices is a non-transitory MRM comprising RAM, an Electrically-Erasable Programmable ROM (EEPROM), a storage drive, an optical disc, and the like. In this example, the quantization circuitry 110 can be disposed in the accelerator 109. The accelerator 109 can also include MAC units 112. The MAC units 112 can include the array 113 (e.g., memory array) comprising multi-level cells (MLC). Although the MAC unit 112 is shown as including the array 113, the MAC unit 112 can include multiple arrays. The accelerator 109 can be hardware, firmware, and/or software configured to implement the ANN 106 utilizing the MAC units 112. The MLCs can be memory cells that can be programmed to any one of three or more data states where each data state represents a different value.

The memory sub-system 111 can be portable, external, or remote storage mediums, for example, that allow the computing device 102 to download the ANN 106, the distribution of voltage-conductance points 107, and/or the operational information 108 from the portable/external/remote storage mediums. In various examples, the ANN 106, the distribution of voltage-conductance points 107, and/or the operational information 108 may be part of an “installation package.” As described herein, the memory sub-system 111 can be encoded with executable instructions for updating the distribution of voltage-conductance points 107, which can be utilized to implement the ANN 106 using the MAC units 112.

In various examples, the ANN 106, the distribution of voltage-conductance points 107, and/or the operational information 108 can be provided to the accelerator 109. The ANN 106, the distribution of voltage-conductance points 107, and/or the operational information 108 can be read from the memory array 105 prior to providing the ANN 106, the distribution of voltage-conductance points 107, and/or the operational information 108 to the accelerator 109. Although the distribution of voltage-conductance points 107 is shown in FIG. 1 as being stored in the memory array 105, the distribution of voltage-conductance points 107 can be stored in the accelerator 109. For example, the distribution of voltage-conductance points 107 can be stored in registers of the accelerator 109. In such examples, the distribution of voltage-conductance points 107 may be accessed by the accelerator 109 without transferring the distribution of voltage-conductance points 107 to the accelerator 109.

The ANN 106 can include weights, biases, and/or activation functions along with other values that are used to implement the ANN 106. The ANN can be trained, which can include updating the weights, biases, and/or activation functions. The ANN 106 can be deployed at the accelerator 109. The ANN 106 can be trained in a binary environment, which can have little or no adverse impact on the output of the ANN 106 due, for example, to the operational binary environment being more reliable than a corresponding analog environment. The ANN 106 can be implemented (e.g., run) in an analog environment such as the accelerator 109. To implement the ANN 106 in an analog environment the weights, biases, and/or activation functions of the ANN 106 can be converted from a digital domain to an analog domain.

The conversion of the weights, biases, and/or activation functions (e.g., the ANN 106) can be inaccurate if the conversion does not consider various noise sources present in the analog domain. An inaccurate conversion of the weights, biases, and/or activation functions can lead to inaccuracies in the inferences generated utilizing the ANN 106.

The conversion process can be accompanied by a quantization process as representing high bit values per parameter is an energy and power intensive operation in the analog domain and can increase the computation's susceptibility to noise. The quantization process can be used to associate the values of the weights, biases, and/or activation functions with conductance levels and/or voltage levels (e.g., voltage-conductance points) used to program memory cells of the array 113 or read memory cells of the array 113. The quantization process can be facilitated utilizing noise sources and/or modelling of noise sources. The quantization process can also be performed utilizing an impact of the noise source and/or their modelling on the accuracy of the ANN 106.

The noise sources and/or their modelling can be referred to as operational characteristics or operational information corresponding to the operation of the array 113, the accelerator 109, the memory sub-system 111, and/or the computing device 102. The conversion of the values (e.g., weights, biases, and/or activation functions) can be susceptible to the operational characteristics of the array 113. The operational characteristics can include, for example, an operational temperature, a power status, and/or current-voltage characteristics of the array 113, the accelerator 109, the memory sub-system 111, and/or the computing device 102. The operational temperature, the power status, and/or the current-voltage characteristics of the array 113 can increase a thermal and/or shot noise experienced by the memory cells of the array 113 which can affect the programming of the memory cells of the array 113 and/or the reading of the memory cells of the array 113. The operational temperature, the power status, and/or the current-voltage characteristics, among others, can be used to dynamically adjust the distribution of voltage-conductance points which allow for the weights, biases, and/or activation functions of the ANN 106 to be accurately programmed utilizing the memory cells of the array 113. Accurately programming the memory cells of the array 113 in view of the operational noise experienced by the array 113 can allow for an increase in an inference accuracy of the ANN 106 as opposed to programming the memory cells without updating the distribution of voltage-conductance points. The distribution of voltage-conductance points can be updated without re-training the ANN 106 (e.g., the weights, biases, and/or activation functions).

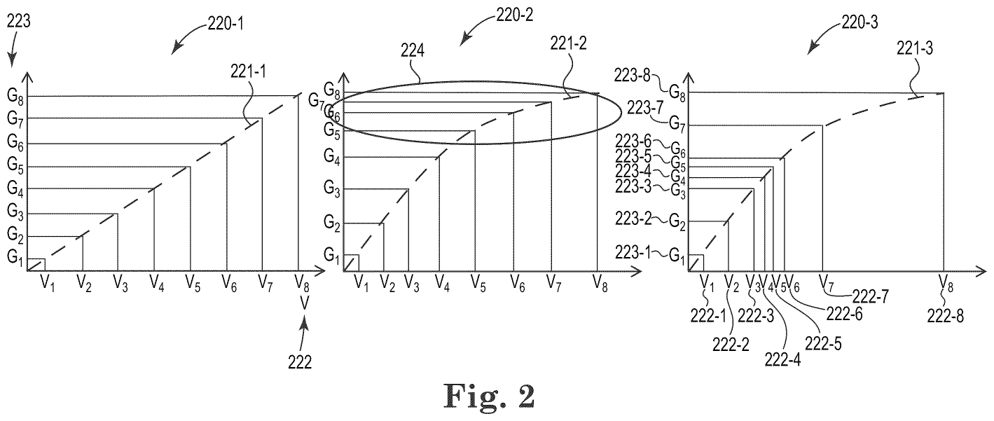

FIG. 2 illustrates graphs 220-1, 220-2, 220-3 showing quantization profiles in accordance with some embodiments of the present disclosure. As used herein, a quantization profile is a distribution of voltage-conductance points which can be selected based on a number of criteria.

The graph 220-1 shows the quantization profile which can include the voltage-conductance points V1-G1, V2-G2-, V3-G3, V4-G4, V5-G5, V6-G6, V7-G7, V8-G8. The graph 220-1 also shows voltage-conductance characteristics 221-1 of the memory cells (e.g., MLCs) of the MAC units of the accelerator. As used herein, the voltage-conductance characteristics 221-1, 221-2, 221-3 are a conductance of the memory cells when a voltage is applied to the memory cells. The voltage-conductance characteristics 221-1, 221-2, 221-3 can be influenced by the operational characteristics. For example, an operational characteristic of a memory sub-system and/or the memory cells of the MAC unit can be affected by, among other things, an age of the memory sub-system and/or the memory cells of the MAC unit. As the memory sub-system and/or the memory cells of the MAC unit age the voltage-conductance characteristics 221-1, 221-2, 221-3 of the memory cells can change.

The voltage-conductance points V1-G1, V2-G2, V3-G3, V4-G4, V5-G5, V6-G6, V7-G7, V8-G8 of the graph 220-1 are shown as being uniformly distributed. The voltages V1, V2, V3, V4, V5, V6, V7, and V8 are uniformly distributed and the conductance G1, G2, G3, G4, G5, G6, G7, and G8 of graph 220-1 are uniformly distributed such that the voltage-conductance points V1-G1, V2-G2, V3-G3, V4-G4, V5-G5, V6-G6, V7-G7, and V8-G8 are uniformly distributed. The voltage-conductance points V1-G1, V2-G2, V3-G3, V4-G4, V5-G5, V6-G6, V7-G7, and V8-G8 of graph 220-1 are distinct and distinguishable such that memory cells can be programmed and read utilizing the voltage-conductance points V1-G1, V2-G2, V3-G3, V4-G4, V5-G5, V6-G6, V7-G7, and V8-G8 with an accuracy greater than a threshold. Each of the voltage-conductance points V1-G1, V2-G2, V3-G3, V4-G4, V5-G5, V6-G6, V7-G7, and V8-G8 can correspond to a different value that the memory cells can be programmed with. The memory cells can be programmed with the different values and the different values can be read from the memory cells utilizing the voltage-conductance points V1-G1, V2-G2, V3-G3, V4-G4, V5-G5, V6-G6, V7-G7, and V8-G8 of graph 220-1.

Graph 220-2 shows voltage-conductance characteristics 221-2. The voltage-conductance characteristics 221-2 dictate that the uniform selection of voltage levels V1, V2, V3, V4, V5, V6, V7, and V8 leads to a selection of non-uniform conductance levels G1, G2, G3, G4, G5, G6, G7, and G8 such that the voltage-conductance points V1-G1, V2-G2, V3-G3, V4-G4, V5-G5, V6-G6, V7-G7, and V8-G8 of graph 220-2 are non-uniform. Selecting uniform voltage levels and non-uniform conductance levels, as shown in graph 220-2 can lead to voltage-conductance points 224 (e.g., V5-G5, V6-G6, V7-G7, and V8-G8) which are non-discernable. Programming memory cells and/or reading memory cells utilizing non-discernable voltage-conductance points 224 can cause errors in reading or programming the memory cells which can cause errors in the inferences generated using the ANN and the memory cells of a MAC unit. For example, values assigned to the voltage-conductance points 224 may be non-discernable one from another when programmed or read from memory cells utilizing the voltage-conductance points 224.

In various instances, non-uniform voltage levels 222-1, 222-2, 222-3, 222-4, 222-5, 222-6, 222-7, 222-8, referred to as voltage levels 222, and non-uniform conductance levels 223-1, 223-2, 223-3, 223-4, 223-5, 223-6, 223-7, 223-8, referred to as conductance levels 223, can be selected as shown in graph 220-3. The voltage levels 222 and the conductance levels 223 can be selected in view of the voltage-conductance characteristics 221-3 of the memory cells and based on the values (e.g., weights, biases, and/or activation functions) of the ANN.

For example, values which comprise more information than other values can be identified. The voltage-conductance points comprising the voltage levels 222 and the conductance levels 223 can be selected to make the values which comprise more information distinguishable and to make the information available to conduct accurate inference in the ANN. For instance, the voltage-conductance points comprising the voltage levels 222-1, 222-2, 222-3, 222-6, 222-7, 222-8 and the conductance levels 223-1, 223-2, 223-3, 223-6, 223-7, 223-8 can be selected to make the conductance levels 223-1, 223-2, 223-3, 223-6, 223-7, 223-8 distinguishable one from another which has the benefit of making corresponding values distinguishable one form another.

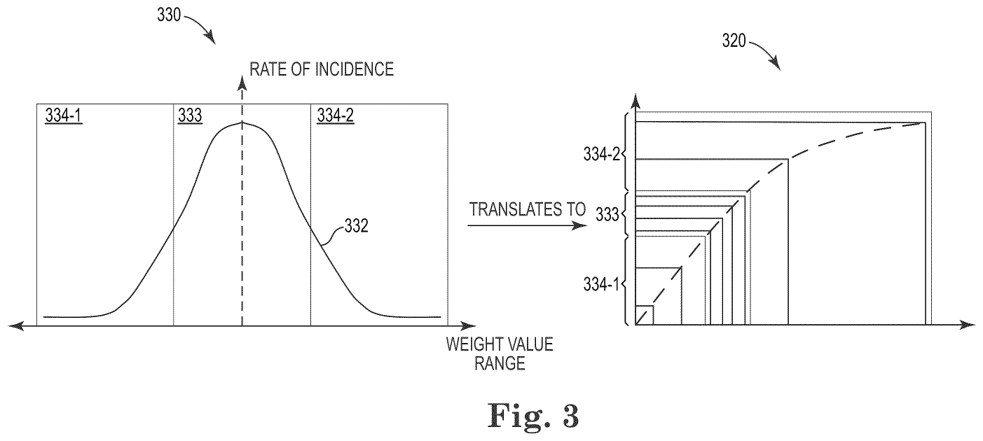

Selecting distinguishable conductance levels can also have the consequence of selecting non-distinguishable conductance levels 223-3, 223-4, 223-5, 223-6 and the corresponding voltage levels 222-3, 222-4, 222-5, 222-6. Utilizing non-distinguishable conductance levels means that corresponding values may not be distinguishable one from another when programming memory cells or reading memory cells utilizing the voltages 222-3, 222-4, 222-5, 222-6. FIG. 3 further describes the selection of distinguishable voltage-conductance points and non-distinguishable voltage-conductance points.

FIG. 3 illustrates graphs 320, 330 showing a quantization profile and a distribution 332 of parameters of an ANN in accordance with some embodiments of the present disclosure. Graph 330 shows a distribution 332 of parameters. Graph 320 shows a quantization profile which includes voltage-conductance points. The voltage-conductance points include conductance levels and voltage levels.

The graph 330 shows the distribution 332 of the parameters (e.g., weights, biases, and/or activation functions) of an ANN. The distribution 332 can be based on a quantity of the parameters (e.g., rate of incidence) and/or on different characteristics of the parameters. For example, the graph 330 shows the distribution 332 based on a quantity of the parameters and based on a value of the parameters (e.g., weights value range). The value of the parameters can be represented based on bits. For instance, the value of the parameters can be graphed using least significant bits (LSB) and most significant bits (MSB), respectively.

In various instances, the parameters can be analyzed to divide the parameters into the smallest values 334-1 and the largest values 334-2 (e.g., weights value range) and the remainder of the values 333. Although, the graph 330 shows the parameters as being divided into three groups (e.g., the smallest values 334-1, the largest values 334-2, referred collectively as outlying values 334 and the remaining values 333), the parameters can be divided into a greater quantity of groups or a lesser quantity of groups than those shown. The division of the parameters can be based on a type of distribution 332 and/or based on a grouping of the parameters that hold the greatest amount of information (e.g., learning) and/or a least amount of information. In various instances, the weight values with the highest rate of incidence can be determined to hold the least amount of information while the weights values (e.g., parameters) with the lowest rate of incidence are determined to hold the greatest amount of information.

The quantization circuitry of an accelerator can process the parameters to determine the distribution 332 of the parameters. The distribution 332 can follow a bell curve pattern as shown in graph 330. However, the parameters can take a different type of distribution 332 other than a bell curve pattern.

The groupings of the parameters and/or the parameters can be mapped to voltage-conductance points based on the distribution and the grouping of the parameters. For example, the parameters 334 and 333 (e.g., value of the parameters) can be mapped to conductance levels as shown in graph 320. The mapped conductance levels can correspond to respective voltage-conductance points. The mapping of the groupings of the parameters and/or the parameters to conductance levels can be such that portions of the conductance levels are discernable one from another and different portions of the conductance levels are non-discernable one from another. The conductance levels mapped to the parameters 334 can be discernable while the conductance levels mapped to the parameters 333 are non-discernable. Non-discernable conductance levels can be bunched such that there is a distance less than a threshold between the non-discernable conductance levels. Reading memory cells utilizing the non-discernable conductance levels makes it so that a read value cannot be accurately discerned as compared to different values corresponding to other non-discernable conductance levels.

By mapping the parameters with the most amount of information to the conductance levels that are discernable allows for a least amount of reading or programming errors to be encountered as compared to mapping the parameters with the least amount of information to the conductance levels that are non-discernable. Mapping the parameters 333 to non-discernable conductance levels sacrifices reading and/or programming errors for the parameters 333 in order to limit the reading and/or programming errors for the parameters 334. This sacrifice allows for an ANN to perform inference with the parameters with the most amount of information which will lead to fewer inference errors as compared to performing inference with the parameters with the least amount of information.

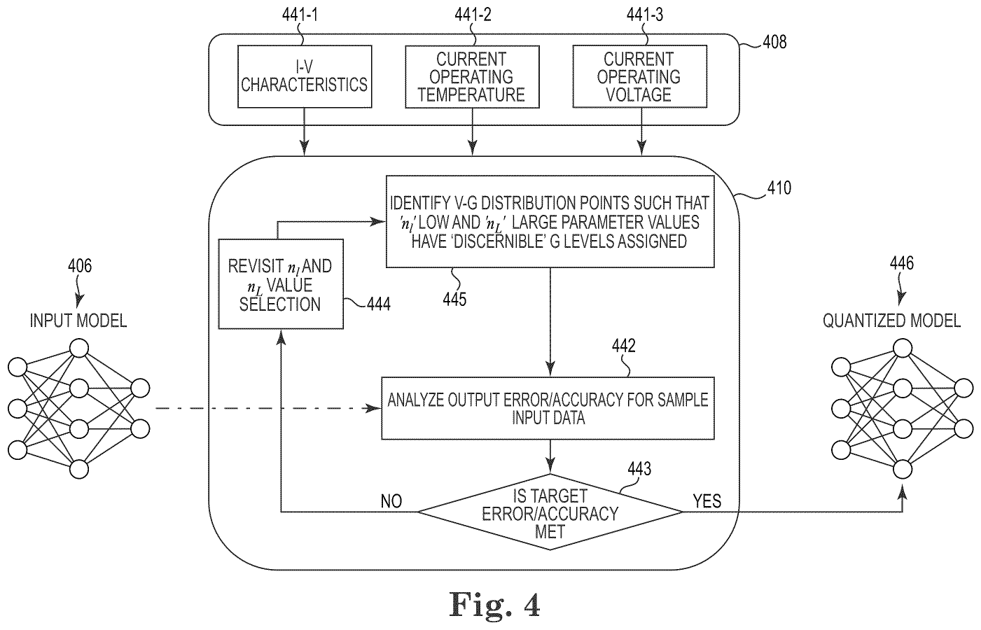

FIG. 4 is a functional block diagram for updating a distribution of voltage-conductance points in accordance with some embodiments of the present disclosure. FIG. 4 shows the quantization circuitry 410, the input model 406, and the output model 446.

The quantization circuitry 410 is hardware and/or firmware configured to update the distribution of voltage-conductance points. The quantization circuitry can receive operational information 408. The operational information 408 can include current-voltage characteristics 441-1, operating temperature 441-2, and operating voltage 441-3. The current-voltage characteristics 441-1 represents a relationship between electric current through the memory sub-system, the array, the MAC, and/or memory cells and the corresponding voltage across the same. The current-voltage characteristics 441-1 of memory cells can change over time and with age (e.g., with use). The operating temperature 441-2 is a temperature of the memory cells, array comprising the memory cells, MAC units comprising the array, accelerator comprising the MAC units, and/or memory sub-system comprising the accelerator. The voltage-conductance characteristics of the memory cells can change based on the operating temperature 441-2. The operating voltage 441-3 can describe a supply voltage used to operate the memory cells, the array, the MAC units, the accelerator, and/or the memory sub-system. The operational information 408 along with the parameters of the input model (e.g., input ANN) can be used to update the distribution of voltage-conductance points used to store or read the parameters in the memory cells.

The operational information 408 and the input model 406 can be received by the quantization circuitry 410 from a main memory array of the memory sub-system. The operational information 408 and the input model 406 can be received by the quantization circuity 410 prior to storing the input model 406 and/or the quantized model 446 in the memory array of the MAC units of the accelerator. For example, upon storage of the input model 406 in the main memory of the memory sub-system, the input model 406 can be provided to the quantization circuitry 410 for processing. In various instances, the input model 406 can be provided to the quantization circuitry 410 prior to storing the input model 406 in the main memory of the memory sub-system. The input model 406 may be converted to the quantization model 446 without storing the input model 406 in the main memory. Instead, the quantized model 446 may be stored in the main memory.

At 442, the input model 406 can be analyzed to determine whether an accuracy of the inference generated using the input model 406 is greater than a threshold (e.g., accuracy threshold). The input model 406 can also be analyzed by the quantization circuitry 410 to determine whether the errors of the output of the input model 406 are greater than a threshold.

The input model 406 can be analyzed at 442 utilizing the voltage-conductance distribution points accessed by the quantization circuitry 410. The voltage-conductance distribution points, prior to being updated, can be default voltage-conductance distribution points. The voltage-conductance distribution points, prior to being updated, can also be associated with a different ANN. The input model 406 can be analyzed utilizing sample input data. For example, the input model 406 can be used to perform operations utilizing the input data to generate an inference (e.g., output data).

The input model 406 can be analyzed by, for example, storing the weights, biases, and/or activation functions in arrays of the MAC units and utilizing the MAC units to perform the operations of the ANN which the input model 406 represents. The default voltage-conductance points can be utilized to store the weights, biases, and/or activation functions in the memory cells of the array. The default voltage-conductance points can also be utilized to read the weights, biases, and/or activation functions from the memory cells of the array.

The sample data (e.g., input data) can be stored in the main memory of the memory sub-system. The sample data can be read from the main memory and provided to the quantization circuitry 410. The sample data can be used as an input to the input model 406 to generate an inference.

At 443, a determination can be made as to whether an accuracy of the inference generated using the input model 406 is greater than the threshold. If accuracy of the inference generated using the input model 406 is greater than a threshold or the errors of the output of the input model 406 are less than a different threshold, then the input model 406 can be converted to the quantized model 446 without any changes to the input model 406. If an accuracy of the inference generated using the input model 406 is less than a threshold or the errors of the output of the input model 406 are greater than the different threshold, the distribution of voltage-conductance points can be modified.

In various instances, the distribution of voltage-conductance points corresponding to the input model 406 can be accessed when the input model 406 is received by the quantization circuitry 410. For example, the distribution of voltage-conductance points can be stored in main memory. The distribution of voltage-conductance points can be provided with the input model 406 to the quantization circuitry 410. In various examples, the distribution of voltage-conductance points can be considered part of the input model 406.

The distribution of voltage-conductance points can also be stored in the accelerator. For example, the distribution of voltage-conductance points can be stored in registers of the accelerator, among other locations. The quantization logic 410 can access the distribution of voltage-conductance points from the accelerator.

At 444, the parameter values having the most information from a plurality of parameter values of the input model 406 can be identified and selected responsive to determining that the target/error accuracy of the input model 406 is not met. The selected parameter values can be divided into groups denoted in FIG. 4 as a low parameter value nₗ and a high parameter value n_{L}. The selected parameter values can differentiate the low values 334-1 from the remainder values 333 and the high values 334-2 from the remainder values 333 as shown in FIG. 3. The parameter values can be selected as described in FIG. 3.

At 445, voltage-conductance points can be identified. The voltage-conductance points can be assigned to the plurality of parameter values such that nₗ and n_{L} are assigned to discernible conductance levels as discussed with relation to graph 320 in FIG. 3. The identified voltage-conductance points can be used to update the previous voltage-conductance points (e.g., default). For example, registers of the accelerator that store the previous voltage-conductance points can be updated with the identified voltage-conductance points to update the distribution of voltage-conductance points.

Responsive to identifying the voltage-conductance points, the errors/accuracy of the input model 406 can be analyzed once again at 442. The second iteration of 442 can be performed with the updated voltage-conductance points. The selection of the parameter values nₗ and n_{L} and the updating of the voltage-conductance points can be performed multiple times based on the accuracy of the input model 406 until a threshold of accuracy is reached.

Once the threshold of accuracy is reached, the quantized model 446 can be generated. The quantized model 446 can include the same weights, biases, and/or activation functions as the input model 406 but can be stored in an MLC array of the MAC using the updated voltage-conductance points. The distribution of voltage-conductance points associated with the quantized model 446 can be stored in the registers of the accelerator or in the main memory of the memory sub-system. Storing the updated distribution of voltage-conductance points in the main memory allows for the updated voltage-conductance points to be utilized without having to re-identify the updated voltage-conductance points next time the input model 406 is implemented in the accelerator.

If the updated distribution of voltage-conductance points is not stored, then the quantized model 446 can exist during execution of the quantized model 446 but may cease existing after the quantized model 446 is executed. For example, the updated distribution of voltage-conductance points may be utilized to store and read the memory cells of the arrays of the MAC units of the accelerator but may not be available after the quantized model 446 is executed which would revert back to the input model 406 because the distribution of voltage-conductance points is unavailable.

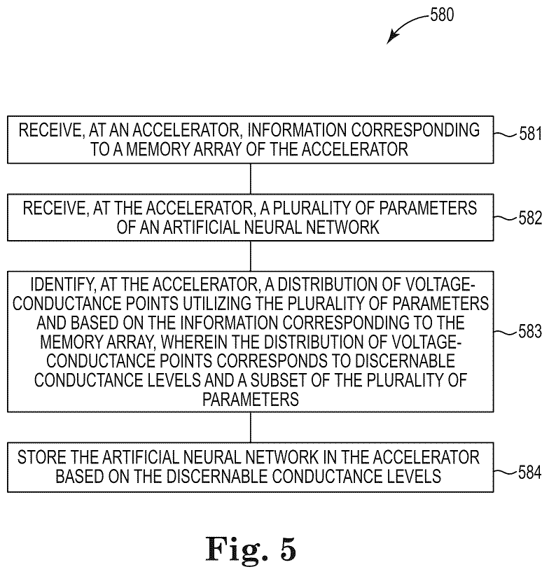

FIG. 5 is a flow diagram corresponding to a method 580 for updating a distribution of voltage-conductance points in accordance with some embodiments of the present disclosure. The method 580 may be performed, in some examples, using a computing system such as those described with respect to FIG. 1.

At 581, information corresponding to a memory array of an accelerator is received at the accelerator. For example, the memory array can be implemented in MAC units of the accelerator. The accelerator can be implemented in a memory sub-system. The accelerator can be coupled to a controller of the memory sub-system and main memory (e.g., memory array) of the memory sub-system. At 582, a plurality of parameters of an ANN can be received at the accelerator. The parameters of the ANN can include weights, biases, and/or activation functions of the ANN.

At 583, voltage-conductance points can be identified at the accelerator utilizing the plurality of parameters and based on the information corresponding to the memory array. The voltage-conductance points can correspond to discernable conductance levels and a subset of the plurality of parameters. For example, the voltage-conductance points can associate parameters with conductance levels. The conductance levels can be discernable because the associated parameters can be accurately read and written to the memory array of the MAC units of the accelerator. At 584, the ANN can be stored in the accelerator based on the discernable conductance levels. Storing the ANN can include storing the plurality of parameters utilizing the voltage-conductance points. The parameters of the ANN can also be read utilizing the voltage-conductance points. The ANN can be stored in the MAC units of the accelerator and/or the memory arrays of the MAC units, for example.

A quantization profile corresponding to the plurality of parameters is generally based on the distribution of voltage-conductance points. The quantization profile can include the distribution of voltage-conductance points. The quantization profile can also map the distribution of voltage-conductance points to the plurality of parameters.

The accuracy of the ANN can be analyzed utilizing a sample set, the quantized profile, and the distribution of voltage-conductance points. Responsive to determining that the accuracy of the ANN is greater than a threshold, the distribution of voltage-conductance points can be utilized to store the ANN in the memory array of the MAC unit. Responsive to determining that the accuracy of the ANN is not greater than a threshold, identifying different voltage-conductance points utilizing the plurality of parameters and based on the information corresponding to the memory array.

In various examples, a controller of a memory sub-system can receive information corresponding to a plurality of memory arrays of the MAC units. An accelerator of the memory sub-system can include multiple MAC units each of the MAC units including one or more memory arrays. The controller can receive a plurality of parameters of an ANN. The parameters can be received from the main memory of the memory sub-system. The controller can identify voltage-conductance points utilizing the plurality of parameters and based on the information corresponding to the plurality of memory arrays. The voltage-conductance points correspond to discernable conductance levels and a subset of the plurality of parameters. Each of the parameters in the subset can be associated with a different one of the discernable conductance levels. The voltage-conductance points can be provided to the accelerator to store the ANN in the MAC units based on the voltage-conductance points. The ANN can be stored in the MAC units by storing the plurality of parameters in the memory arrays of the MAC units.

The information corresponding to the memory arrays of the MAC units include current-voltage characteristics of the memory arrays. The information can also include an operating temperature and/or an operating voltage of the memory arrays.

The controller can also identify two or more voltage-conductance points corresponding to at least a group of discernable conductance levels. The group of discernable conductance levels can have a quantity of conductance levels that is equal to a quantity of parameters from the subset of the plurality of parameters. The group of discernable conductance levels corresponds to parameters with a rate of incidence below a threshold. The parameters with the rate of incidence below the threshold hold an amount of information that impacts an accuracy of the ANN above a different threshold. The rate of incidence can be a quantity of times a parameter (e.g., parameter value) is included in the plurality of parameters.

The controller can identify two or more voltage-conductance points corresponding to a group of non-discernable conductance levels. The non-discernable conductance levels are conductance levels used to store or read corresponding parameters with an accuracy below a threshold. The group of non-discernable conductance levels are non-discernable comparative to at least one adjacent conductance level. The adjacent conductance level is a discernable conductance level. The non-discernable conductance levels can be grouped such that the distance between the conductance levels is such that when utilized to read or store data in memory cells the distance between the conductance levels leads to error in reading or storing the data. The group of non-discernable conductance levels corresponds to parameters with a rate of incidence above a threshold. For example, the most used parameters can be associated with the non-discernable conductance levels. The parameters with the rate of incidence above the threshold hold an amount of information that impacts an accuracy of the ANN below a threshold (e.g., a different threshold).

In various examples a distribution of voltage-conductance points can be accessed. An accelerator can access the distribution of voltage-conductance points from registers of the accelerator or from the main memory of a memory sub-system that hosts the accelerator. The accelerator can receive a plurality of parameters of an ANN. The plurality of parameters can be received from the main memory of the memory sub-system. The accelerator can store the plurality of parameters in a memory array of a MAC unit of the accelerator. The accelerator can store the plurality of parameters in preparation to executing the ANN and generating an inference. The accelerator can read the plurality of parameters from the memory array utilizing the distribution of voltage-conductance points to interpret signals received from reading the memory array. The accelerator can read the plurality of parameters as part of the execution of the ANN.

The distribution of voltage-conductance points can correspond to parameters, from the plurality of parameters, represented using LSBs. The distribution of voltage-conductance points can correspond to parameters, from the plurality of parameters, represented using MSBs. The accelerator can determine the parameters represented using LSB and MSB.

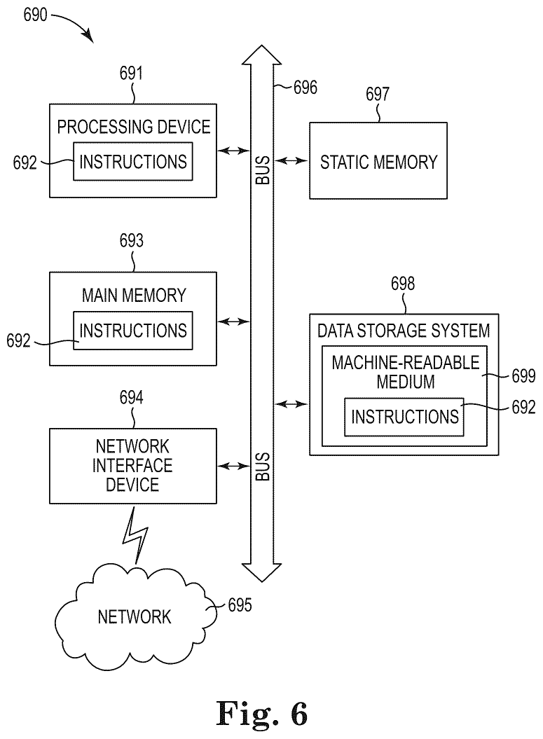

FIG. 6 is a block diagram of an example computer system 690 in which embodiments of the present disclosure may operate. For example, FIG. 6 illustrates an example machine of a computer system 690 within which a set of instructions, for causing the machine to perform any one or more of the methodologies discussed herein, can be executed. In some embodiments, the computer system 690 can correspond to a host system that includes, is coupled to, or utilizes a memory sub-system (e.g., the memory sub-system 111 of FIG. 1). The computer system 690 can be used to perform the operations described herein (e.g., to perform operations corresponding to the quantization circuitry 110 of FIG. 1). In alternative embodiments, the machine can be connected (e.g., networked) to other machines in a LAN, an intranet, an extranet, the Internet, and/or wireless network. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 690 includes a processing device (e.g., processor) 691, a main memory 693 (e.g., read-only memory (ROM), flash memory, dynamic random access memory (DRAM) such as synchronous DRAM (SDRAM) or Rambus DRAM (RDRAM), etc.), a static memory 697 (e.g., flash memory, static random access memory (SRAM), etc.), and a data storage system 698, which communicate with each other via a bus 696.

The processing device 691 represents one or more general-purpose processing devices such as a microprocessor, a central processing unit, or the like. More particularly, the processing device 691 can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 691 can also be one or more special-purpose processing devices such as an application specific integrated circuit (ASIC), a field programmable gate array (FPGA), a digital signal processor (DSP), network processor, or the like. The processing device 691 is configured to execute instructions 692 for performing the operations and steps discussed herein. The computer system 690 can further include a network interface device 694 to communicate over the network 695.

The data storage system 698 can include a machine-readable storage medium 699 (also known as a computer-readable medium) on which is stored one or more sets of instructions 692 or software embodying any one or more of the methodologies or functions described herein. The instructions 692 can also reside, completely or at least partially, within the main memory 693 and/or within the processing device 691 during execution thereof by the computer system 690, the main memory 693 and the processing device 691 also constituting machine-readable storage media. The machine-readable storage medium 699, data storage system 698, and/or main memory 693 can correspond to the memory sub-system 111 of FIG. 1.

In one embodiment, the instructions 692 include instructions to implement functionality corresponding to examples described herein (e.g., using the quantization circuitry of FIG. 1). While the machine-readable storage medium 699 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
receiving, at an accelerator, information corresponding to a memory array of the accelerator;
receiving, at the accelerator, a plurality of parameters of an artificial neural network (ANN);
identifying, at the accelerator, a distribution of voltage-conductance points utilizing the plurality of parameters and based on the information corresponding to the memory array,
wherein the distribution of voltage-conductance points corresponds to discernable conductance levels and a subset of the plurality of parameters; and
storing the ANN in the accelerator based on the discernable conductance levels.

2. The method of claim 1, further comprising generating a quantization profile corresponding to the plurality of parameters based on the distribution of voltage-conductance points.

3. The method of claim 2, further comprising analyzing an accuracy of the ANN utilizing a sample set, the quantization profile, and the distribution of voltage-conductance points.

4. The method of claim 3, further comprising, responsive to determining that the accuracy of the ANN is greater than a threshold, utilizing the voltage conductance distribution points to store the ANN in the memory array of a MAC unit of the accelerator.

5. The method of claim 3, further comprising, responsive to determining that the accuracy of the ANN is not greater than a threshold, identifying a different distribution of voltage-conductance points utilizing the plurality of parameters and based on the information corresponding to the memory array.

6. An apparatus comprising:
an accelerator comprising multiply and accumulate (MAC) units having a plurality of memory arrays;
a controller coupled to the accelerator and configured to:
receive information corresponding to the plurality of memory arrays of the MAC units;
receive a plurality of parameters of an artificial neural network (ANN);
identify a distribution of voltage-conductance points utilizing the plurality of parameters and based on the information corresponding to the plurality of memory arrays;
wherein the distribution of voltage-conductance points correspond to discernable conductance levels and a subset of the plurality of parameters; and
provide the distribution of voltage-conductance points to the accelerator to store the ANN in the MAC units based on the distribution of voltage-conductance points.

7. The apparatus of claim 6, wherein the information corresponding to the memory arrays of the MAC units includes current-voltage characteristics of the memory arrays.

8. The apparatus of claim 6, wherein the information corresponding to the memory array of the MAC unit includes an operating temperature of the memory array.

9. The apparatus of claim 6, wherein the information corresponding to the memory array of the MAC unit includes an operating voltage of the memory array.

10. The apparatus of claim 6, wherein the controller is further configured to identify two or more voltage-conductance points corresponding to at least a group of discernable conductance levels.

11. The apparatus of claim 10, wherein the group of discernable conductance levels corresponds to parameters with a rate of incidence below a threshold.

12. The apparatus of claim 11, wherein the parameters with the rate of incidence below the threshold hold an amount of information that impacts an accuracy of the ANN above a different threshold.

13. The apparatus of claim 6, wherein the controller is further configured to identify two or more voltage-conductance points corresponding to a group of non-discernable conductance levels.

14. The apparatus of claim 13, wherein the group of non-discernable conductance levels are non-discernable comparative to at least one adjacent conductance level.

15. The apparatus of claim 13, wherein the group of non-discernable conductance levels corresponds to parameters with a rate of incidence above a threshold.

16. The apparatus of claim 15, wherein the parameters with the rate of incidence above the threshold hold an amount of information that impacts an accuracy of the ANN below a different threshold.

17. A non-transitory machine-readable medium having computer-readable instructions, which when executed by a computer, cause the computer to:
access a distribution of voltage-conductance points;
receive a plurality of parameters of an artificial neural network (ANN);
store the plurality of parameters in a memory array of a multiply and accumulate (MAC) unit of an accelerator; and
read the plurality of parameters from the memory array utilizing the distribution of voltage-conductance points to interpret signals received from reading the memory array.

18. The non-transitory machine-readable medium of claim 17, wherein the distribution of voltage-conductance points corresponds to parameters, from the plurality of parameters, represented using least significant bits (LSB).

19. The non-transitory machine-readable medium of claim 17, wherein the distribution of voltage-conductance points corresponds to parameters, from the plurality of parameters, represented using most significant bits (MSB).

20. The non-transitory machine-readable medium of claim 17, wherein the instructions are further executable to determine the parameters represented using LSB and MSB.
